(19) United States
(12) Patent Application Publication
(10) Pub. No.: US 2009/0167506 A1
(43) Pub. Date: Jul. 2, 2009

(54) METHOD OF CONTROLLING NETWORKED KITCHEN APPLIANCES

(75) Inventor: Alfred Sing Ping Wong, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: DEFOND COMPONENTS LIMITED, Chaiwan (HK)

(21) Appl. No.: 11/968,269

(22) Filed: Jan. 2, 2008

(51) Int. Cl. G08B 1/00

(52) U.S. Cl. 340/286.02

(57) ABSTRACT

A method of controlling the operation of a wireless network of intelligent kitchen appliances for performing a recipe allows a user to provide authentication of commands received over the network by manual actuation of a touch-sensitive switch mounted to the appliance, and which initiates operation according to the command. A hand-held remote controller has a display for showing instructions to the user. The controller transmits associated appliance commands to the appliance, where they are stored, and the appliance then performs each appliance command conditionally, upon a change of state of the switch.

### TECHNICAL FIELD

The present invention relates generally to electric kitchen appliances and, more particularly, to a method of controlling the operation of networked kitchen appliances.

### BACKGROUND OF THE INVENTION

Miniaturised electronics have enabled the implementation of increasingly complex functions in kitchen appliances. Stand-alone intelligent cooking appliances have been developed to assist users in following recipes, common examples including bread-makers and microwave ovens. By selecting only a desired recipe or programme from a range of pre-defined options, the appliance will automatically perform a sequence of different steps, avoiding the need to define the parameters of each step independently. Typically, a relatively complex operator interface is required in order to invoke the various programmes that are available. Also due to the sophistication and complexity of the controls, owner's manuals for such appliances tend to be voluminous and difficult to comprehend, increasing the difficulty of following recipes, particularly where it is necessary to use more than one appliance.

To address some of the drawbacks of these stand-alone appliances, and particularly to allow users to follow cooking recipes more easily, systems of networked kitchen appliances have been developed, U.S. Pat. No. 6,690,979 describes a method of operating kitchen appliances connected in a network to communicate with a remote control computer. This method allows users to interact with the system in response to an instruction sequence loaded onto the control computer which includes user instructions for the stages in following a recipe and which are shown on a display associated with the computer. The control computer directly controls the appliance and the instruction sequence also includes appliance commands that are automatically executed by the appliance upon their receipt from the control computer. The appliance control circuit may include interlock logic preventing operation in some circumstances, such as when the door of a microwave is open. An error signal sent from the appliance back to the remote controller can alert the user to this problem.

Although the above-mentioned system provides a greater degree of interaction with the user, this system and other prior art kitchen appliance networks known to the applicant suffer from another drawback. One aspect of conventional non-networked appliance safety is the necessity for the user to manually start its operation, for instance by use of a touch-sensitive switch on the appliance. This allows a check to be made on the appliance itself confirming that it is safe or otherwise desirable to start. When pre-heating an oven, for example, it may be desired to avoid heating any items already in the oven. However, in the prior art systems switch means for confirming start of the appliance is provided on the remote control computer. Moreover, particularly when using a wireless network, it will be understood that a double-check or authentication of appliance commands would be advantageous, due to the potential for unauthorised operation or interference. Wireless network components can be purchased at low cost and require no expertise to set up, however technically unaware users who fail to implement available security features leave their networks vulnerable and the widespread use of wireless networks means that there may be many potential network intruders within range of a home network.

### DISCLOSURE OF THE INVENTION

According to one aspect of the present invention there is provided a method of controlling an operation of a kitchen appliance having a control circuit responsive to a change of state of a touch-sensitive switch mounted to the appliance for manual actuation by a user, the method comprising:

providing a hand-held controller remote from the appliance, the controller having a controller display;

wirelessly connecting the appliance to the controller;

loading an instruction sequence into the controller, the instruction sequence including user and appliance sets of commands directed to the user and the appliance respectively;

initiating execution of the instruction sequence by the controller to show at least a first user command on the controller display;

transmitting a first appliance command to the appliance;

storing the first appliance command in the control circuit, and

operating the appliance control circuit to perform the first appliance command conditionally upon a change of state of the switch.

In another aspect of the present invention there is provided a method of controlling an operation of a kitchen appliance having a control circuit responsive to a change of state of a touch-sensitive switch mounted to the appliance for manual actuation by a user, the method comprising:

providing a hand-held controller remote from the appliance, the controller having a controller display;

wirelessly connecting the appliance to the controller;

loading an instruction sequence into the controller, the instruction sequence including user and appliance sets of commands directed to the user and the appliance respectively;

initiating execution of the instruction sequence by the controller to show at least a first user command on the controller display;

transmitting a first appliance command to the appliance and pausing execution of commands in the appliance set;

operating the appliance control circuit to perform the first appliance command conditionally upon a change of state of the switch;

actuating the appliance to transmit a completion signal to the remote controller following performance of the first appliance command by the appliance, and

resuming execution of commands in the appliance set by the controller conditionally upon receipt of the completion signal by the controller.

Preferably the method includes operating the appliance control circuit to perform the each appliance command conditionally upon a respective change of state of the switch.

Preferably between pausing and resuming execution of commands in the appliance set, the execution of the instruction sequence comprises showing at least a second user command on the controller display.

Preferably the user commands comprise video shown on the controller display. Alternatively the user commands may comprise text shown on the controller display.

Preferably the method further comprises connecting the controller to the internet; accessing a remote database holding instruction sequences; and downloading the instruction sequence via the internet.

Preferably the instruction sequence comprises a recipe including at least one cooking step.

Preferably the appliance constitutes an oven.

Preferably the recipe comprises a step for automatically turning on the oven.

Preferably the recipe comprises a step for automatically preheating said oven.

Preferably the recipe comprises steps for: creating an uncooked mixture of ingredients; inserting said mixture in the oven; controlling the oven; and removing the mixture from said oven.

This invention thus provides a method of controlling an operation of a kitchen appliance which is effective for providing a double-check or authentication of appliance commands, increasing safety in the operation of networked kitchen appliances.

### BRIEF DESCRIPTION OF THE DRAWINGS

Preferred forms of the present invention will now be described by way of example with reference to the accompanying drawings, wherein:

FIG. 1 is a schematic illustration of a network of kitchen appliances according to the invention

FIG. 2 is a schematic illustration of the appliance control circuit and remote controller of FIG. 1

FIG. 3 is a flow chart showing the general operation of the method of the invention, and

FIG. 4 is a flow chart showing an exemplary operation of the applicances of FIG. 1.

### DESCRIPTION OF THE PREFERRED EMBODIMENTS

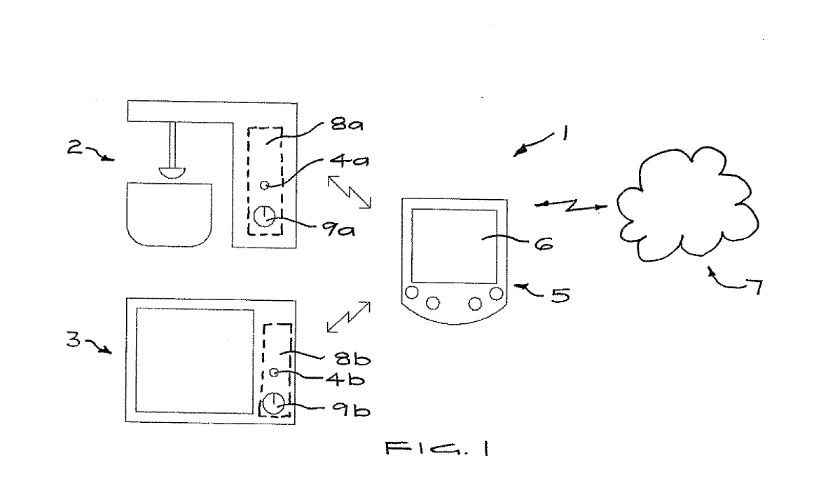

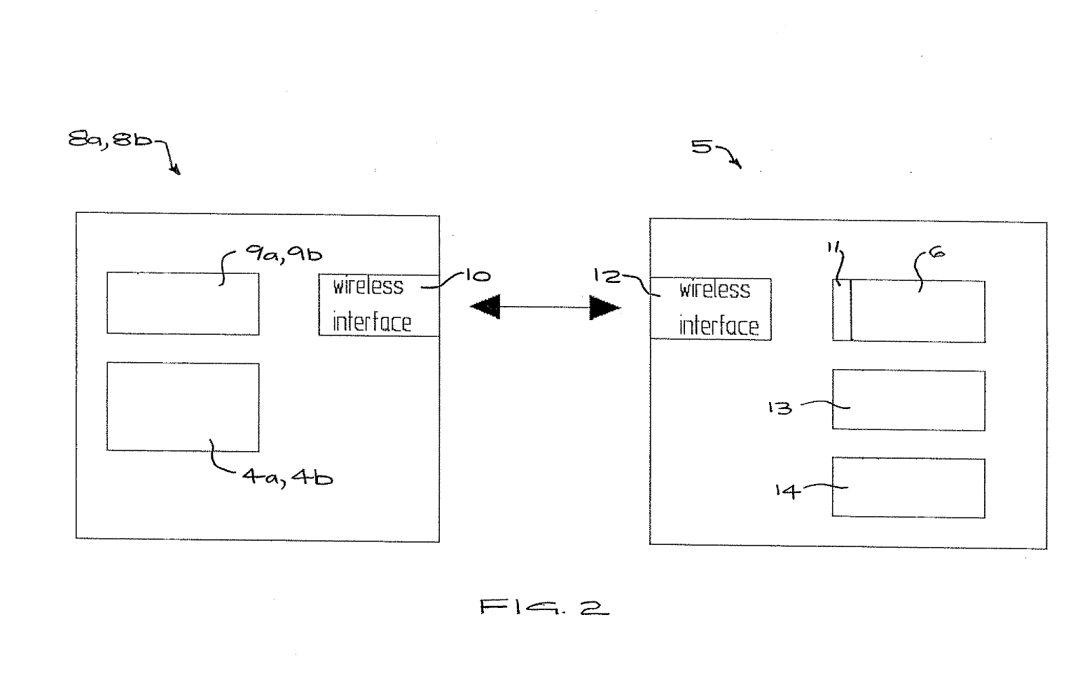

Referring to FIGS. 1 and 2, an exemplary network 1 according to the invention includes appliances, such as an electric mixer 2 and an oven 3 each connected wirelessly for bi-directional communication with a hand-held computer controller 5. Mounted externally, each of the appliances 2, 3 have a respective touch-sensitive switch 4a, 4b and input device 9a, 9b for manual actuation by a user and connected to an internally-mounted control circuit 8a, 8b. The control circuits 8a, 8b include wireless interfaces 10, a processor (not shown) and memory (not shown), as well as electrical connections (not shown) for controlling the motors, elements etc of the appliances 2, 3.

The controller 5 may be in the form of a personal data assistant (PDA) or smart phone having a processor (not shown) and memory (not shown), a display 6, an audio output 11, a wireless interface 12, input devices 13 and a modem 14 or other network device for wirelessly accessing external databases or the internet 7. By accessing an internet web site which contains various recipes, an instruction sequence associated with each recipe can be downloaded to the controller 5 and stored in memory or immediately executed. This gives the user the ability to select new instruction sequences to be executed by the network 1.

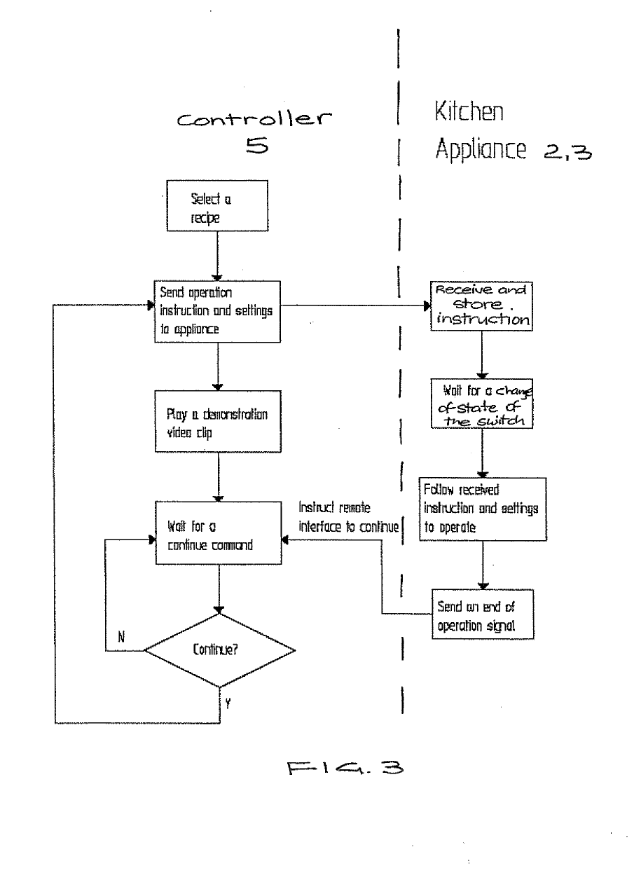

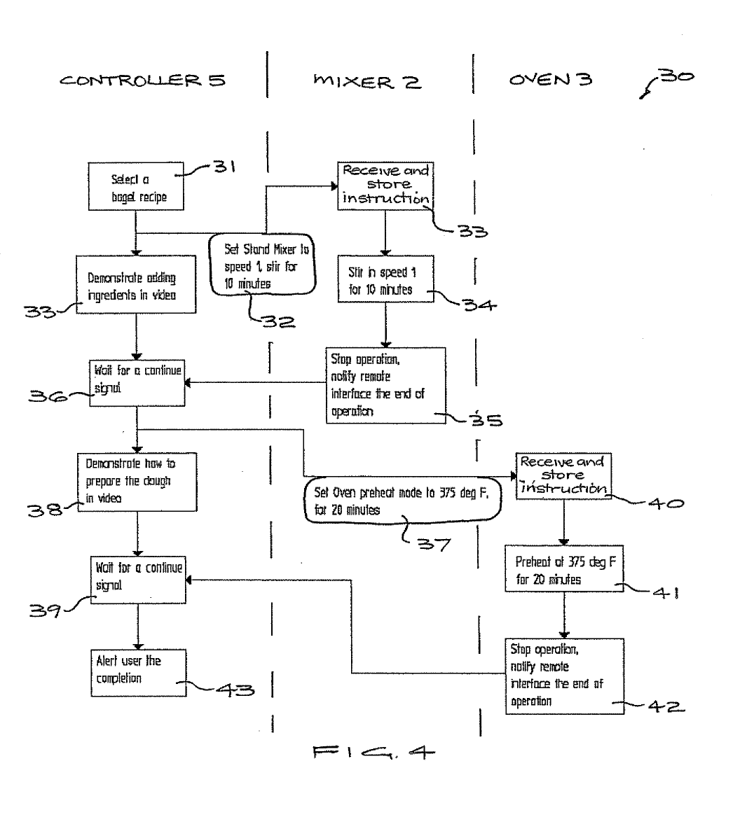

The instruction sequences used with the invention direct both the user and the appliance, as shown in FIGS. 3 and 4. When the instruction sequence is executed, the controller 5 directs either the user to complete the command or transmits the command to the appliance 2, 3. If it is to be completed by the user, the controller 5 alerts the user as to the existence of the command and instructs the user what to do by playing a demonstration video clip through the display 6 and audio output 11. A video-type interface is provided, allowing the user to play the video clip and vary its speed as well as rewind, pause, stop etc. Following the end of the video clip the controller 5 pauses until directed to continue by the user (such as by again depressing a “Play” button). If, however, the command is to be completed by an appliance 2, 3, the controller 5 first determines which appliance, and then sends the command to the correct appliance, via the network 1, for storage in respective the control circuit 8a, 8b. The user is then able to check the appliance and press the respective switch 4a, 4b. The control circuit 8a, 8b monitors the state of the switch 4a, 4b and upon a change of state of the switch the instructions are performed by the appliance. The last command from the appliance is to alert the user via the controller 5 that the appliance command has been completed.

FIG. 4 depicts part of a recipe procedure 30 in accordance with the invention, which employs both the electric mixer 2 and an oven 3. Prior to starting the procedure 30 the user may access the internet to search for a recipe available from a website. The website may allow selection of recipes be made, as well as variations in the parameters of each recipe (variations in cooking times, etc) to provide a product according to the user's tastes.

Selection of the bagel recipe at step 31 operates the controller 5 to transmit a first appliance command 32 to the mixer 2 and to play a first user command in the form of the video clip 33. The user command 33 explains the first step required to cook a bagel, being adding the ingredients to the mixer 2. The associated appliance command 32 sets the mixer speed and duration of mixing. Following the end of the video clip 33, the controller 5 pauses the execution of further user commands at step 36 and disables the “Play” button. At step 33 the appliance command 32 is received and stored, pending a change in state of the switch 4a. To then proceed with the appliance command the user checks that the appliance is ready and actuates the switch 4a. It is unnecessary to receive further data from the controller, the stored command is then executed by the control circuit 8a to operate the mixer 2 accordingly at step 34, conditional upon prior actuation of the switch 4a. A completion signal at step 35 is sent to the controller 5 to indicate completion of the appliance command 34. At step 36 the user may be advised via the display 6 and audio 11 that the mixing is complete, or the “Play” button may be enabled.

The controller 5 is operated to transmit a second appliance command 37 to the oven 3 and to play a second user command in the form of the video clip 38 explaining the next required step, being preparation of the dough. At this stage in the procedure it is necessary to pre-heat the oven and the associated appliance command 37 sets the temperature and duration of operation. Following the end of the video clip 38, the controller 5 pauses the execution of further user commands at step 39 and disables the “Play” button. At step 40 the appliance command 37 is received and stored, pending a change in state of the switch 4b. The user can check the oven before actuation the switch 4b to provide confirmation that the appliance should operate. The stored command is executed by the control circuit 8b to operate the oven 3 accordingly at step 41 following user actuation of the switch 4b. A completion signal at step 42 is sent to the controller 5 to indicate completion of the appliance command 41. At step 43 the user is advised via the display 6 and audio 11 that the preheat is complete.

Aspects of the present invention have been described by way of example only and it should be appreciated that modifications and additions may be made thereto without departing from the scope thereof.

1. A method of controlling an operation of a kitchen appliance having a control circuit responsive to a change of state of a touch-sensitive switch mounted to the appliance for manual actuation by a user, the method comprising:
providing a hand-held controller remote from the appliance, the controller having a controller display;
wirelessly connecting the appliance to the controller;
loading an instruction sequence into the controller, the instruction sequence including user and appliance sets of commands directed to the user and the appliance, respectively;
initiating execution of the instruction sequence by the controller to show at least a first user command on the controller display;
transmitting a first appliance command to the appliance;
storing the first appliance command in the control circuit; and
operating the appliance control circuit to perform the first appliance command conditionally, upon a change of state of the switch.

2. The method of claim 1 including operating the appliance control circuit to perform each appliance command conditionally, upon a respective change of state of the switch.

3. The method of claim 2, wherein, between pausing and resuming execution of commands in the appliance set, the execution of the instruction sequence comprises showing at least a second user command on the controller display.

4. The method of claim 1, wherein the user commands comprise video shown on the controller display.

5. The method of claim 1 further comprising:
connecting the controller to the internet;
accessing a remote database holding instruction sequences; and
downloading the instruction sequence via the internet.

6. The method of claim 1 wherein the instruction sequence comprises a recipe including at least one cooking step.

7. The method of claim 6 wherein the appliance is selected from the group consisting of an oven and an electric mixer.

8. The method of claim 7 wherein the appliance is an oven and the recipe comprises automatically turning on the oven.

9. The method of claim 8 wherein the appliance is an oven and the recipe comprise automatically preheating the oven.

10. The method of claim 6 wherein the appliance is an oven and the recipe comprise:
creating an uncooked mixture of ingredients;
inserting the mixture in the oven;
controlling the oven; and
removing the mixture from the oven.

11. A method of controlling an operation of a kitchen appliance having a control circuit responsive to a change of state of a touch-sensitive switch mounted to the appliance for manual actuation by a user, the method comprising:
providing a hand-held controller remote from the appliance, the controller having a controller display;
wirelessly connecting the appliance to the controller;
loading an instruction sequence into the controller, the instruction sequence including user and appliance sets of commands directed to the user and the appliance respectively;
initiating execution of the instruction sequence by the controller to show at least a first user command on the controller display;
transmitting a first appliance command to the appliance and pausing execution of commands in the appliance set;
operating the appliance control circuit to perform the first appliance command conditionally, upon a change of state of the switch;
actuating the appliance to transmit a completion signal to the remote controller following performance of the first appliance command by the appliance; and
resuming execution of commands in the appliance set by the controller conditionally, upon receipt of the completion signal by the controller.
